(19) United States
(12) Patent Application Publication
(10) Pub. No.: US 2006/0212475 A1
(43) Pub. Date: Sep. 21, 2006

(54) Enterprise information management and business application automation by using the AIMS informationbase architecture

(76) Inventor: Nick T. Cheng, Herndon, VA (US)

Correspondence Address: Golden Concept International, Inc., 2537 James Maury Drive, Herndon, VA, 20171, US

(21) Appl. No.: 10/718,709

(22) Filed: Nov. 24, 2003

(51) Int. Cl. G06F 17/00

(52) U.S. Cl. 707/104.1

(57) ABSTRACT

AIMS is design to eventually have computer provide management function to manage other computers (CMC). The process management algorithms is proven to work on higher level of intelligence as long as the business rule can be represented in the digital logic. This will be relief of management on monitoring various indexes in order to make business decision. By the modularized design, the CMC automation can be operated either an integrated part of AIMS or an independent system outside AIMS.

A new architecture of an integrated system for information management, data management and automation management for any business and organization is designed. This architecture consists a complete architectural design of informationbase. Within this architecture, the AIMS (Automated Information management System) can be implemented, which includes the one-push-button design to develop fully customized business automations in the preferred state-of-art intelligent CMC (Computer-Manage-Computer) automation architecture or in the other automation tools and/or applications.

This invention is a new functional system and a corporate foundation database architecture design that can support comprehensive and flexible enterprise information and data management and the business automation. This architecture will let the enterprises to manage their business information and information system development more efficiently, and will let the business operation move into a preferred state-of-art intelligent automation or other automations and applications. Therefore, to the corporate, the management of the enterprise information and automation will become a great corporate asset.

### BACKGROUND OF THE INVENTION

Most IT professional has encountered numerous business management problems that hinder not on the availability of information, but on the digestion and the processes of information and data management. The corporate management has experienced tremendous frustration in how to effectively manage the enterprise information and business automations, even with the assistance from current IT technologies and tools. The Legacy systems inherited by enterprises have many short failings that make the IT development and maintenance expense unreasonable high. The short failings include several major categories as listed below:
a. Applications that is inflexible, redundant, missing, obsolete and/or uncontrollable.
b. Data used for strategic decision-making are missing, redundant, inconsistent, not exchangeable nor sharable among applications.
c. The knowledge of those implemented application systems is very difficult to be leveraged into the other new application system developments or to be used by the business decision support. The result is the unmanageable stovepipe information development and the very expensive discovery processes.
d. The gaps exist between the application implementation and the business definition.
e. The IT tools failed to satisfy different levels of information management and different user groups such as business user and technical staff.

By looking at the issues from the causes, the inventor discovered that all issues are due to incomplete provision of IT resources and all projects are partial remedy cover symptoms of IT issue. There were no attempts to address the fundamental IT issues of providing a comprehensive process and information architecture that can support all IT born projects within an enterprise. Hence, the search for the comprehensive IT architecture design begins which result in the design of informationbase—Automated Information Management System (AIMS) with the inclusion of a state-of-art intelligent Computer-Manage-Computer (CMC) automation architecture.

There were attempts made to provide automation on partial business operation in a specific nature. The inventor's design is to provide a total solution of generic architecture both in information and data management, and automation management, which apply on both levels of project and enterprise.

### BRIEF SUMMARY OF THE INVENTION

The Automated Information Management System (AIMS) is a total integrated information technology architecture, informationbase, upon which all application and data operate freely under the control of the intelligent automated management process provided by the AIMS. AIMS also provide business information, corporate information management, and data management for the enterprise. The design of the AIMS is not that it supports the business process of an enterprise, but it is the integral part of the business. The design is that the AIMS itself is business knowledgebase and business process, which makes AIMS differ from all other IT platforms. Not only control, command and communicate all enterprise processes, AIMS also enable the business to undergo a seamless transformation if desired.

### DIAGRAMS

### Diagram 1

### Brief Description of Diagram 1—Tier Base Architecture

This diagram depicts how the tier base architecture supports the actual implementation of all applications for a generic business operation and information management. The information message access, exchange and automation tier obtain data provided from the AIMS Informationbase foundation database tier and realized the functionalities in the application presentation tier. The user application database with operational database, data warehouse, ODS (Operation Data Store), and staging area shown in the diagram, which may or may not developed by AIMS, is at the same database tier as the AIMS informationbase foundation database.

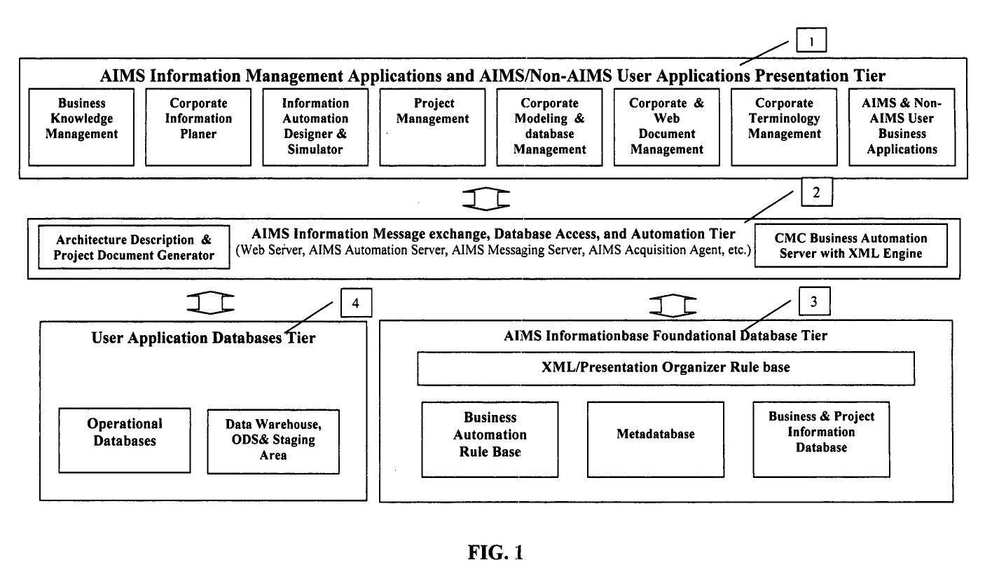

(Same as FIG. 1)

### Diagram 2

### Brief Description of Diagram 2—System and Operation Architecture View

This architecture depicts how the information and processes are managed by AIMS, which is supported by AIMS informationbase foundation database.

GAMS: Generic Automation Management System. BAMS: Computer-Manage-Computer Business Automation Management System

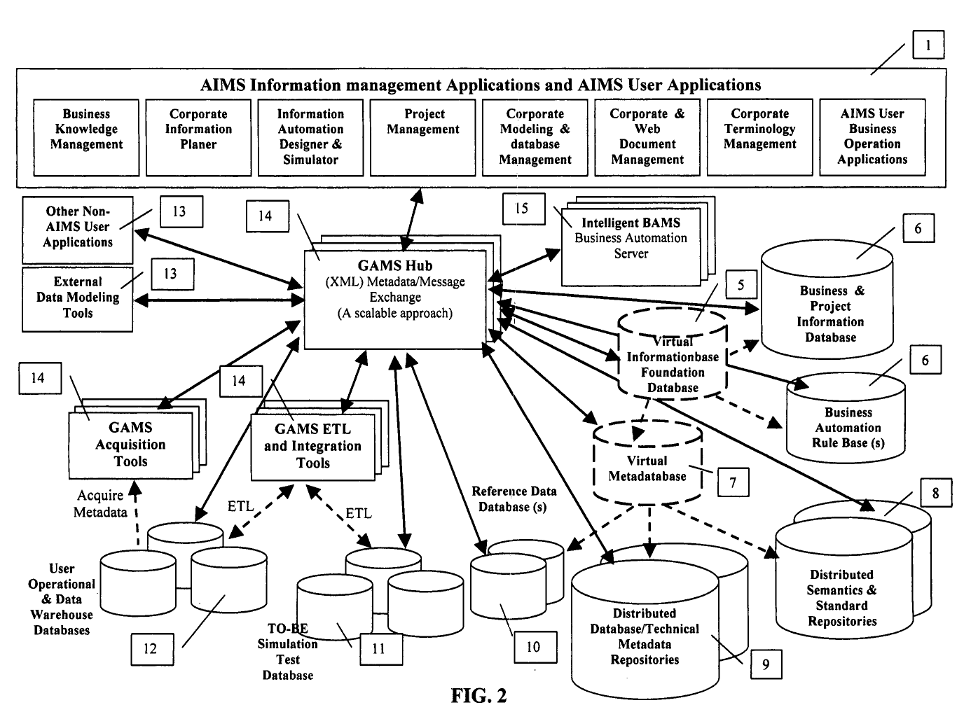

(Same as FIG. 2)

### Diagram 3

### Brief Description of Diagram 3—Conceptual Core Model View of the AIMS Informationbase Foundation Database

This model depicts the high-level core AIMS conceptual models architecture.

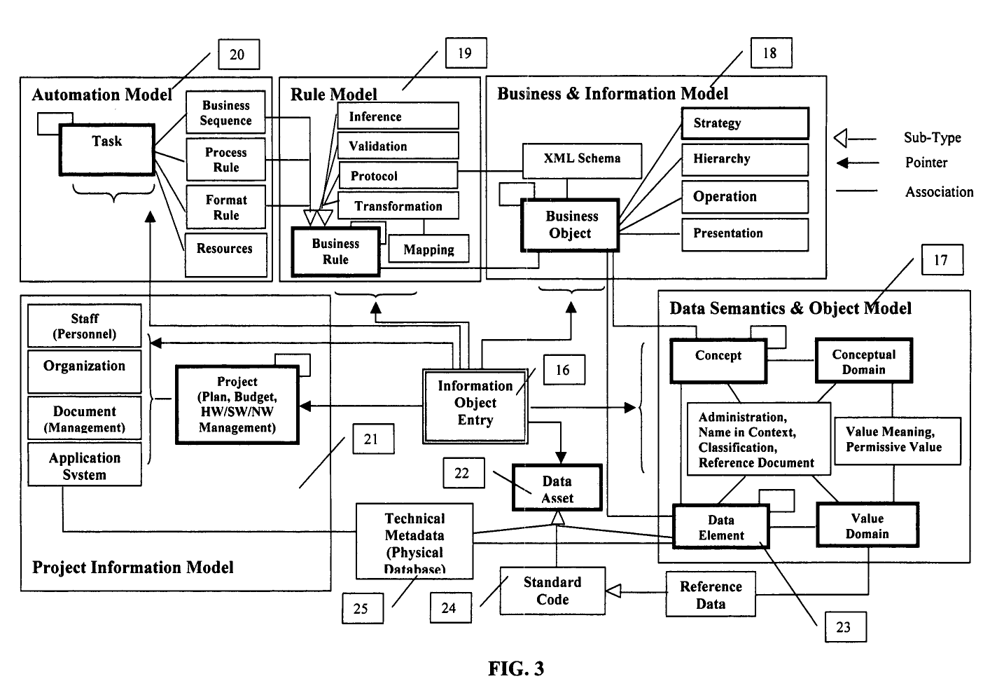

(Same as FIG. 3)

### DETAILED DESCRIPTION OF THE INVENTION

The idea of the management of all prospects of a business within a single integrated system is an ideal operational model of the business management industry. There is no existing architecture or design in the current Information Technology industry that can achieve this goal. Only by a generic informationbase architecture which captures all the business knowledge, business data semantics, and business (operation or process) rules, the comprehensive information management and the one-push-button of generating business process structures and applications in a CMC automation architecture will become possible. The information development management and information quality will not be the management nightmare any more, but will be management assets. With this informationbase, AIMS, the corporate management can have a clear picture about their business operation and the AS-IS information assets and implementation, and can layout the road map to the future TO-BE information architecture. The inventor's design is to incorporate all business information, business processes information, business data information and business rules of an enterprise within a single integrated informationbase architecture. The integrated system can provide automated business and information management in a seamless interchange of information and hence enable the management of the business by computer intelligence fully. Two POC (proofs of concept) prototypes had also been implemented in knowledgebase and metadata management and in generic automation management that will demonstrate that the inventor's architecture works in a real world environment.

Instead of using the terminology knowledgebase for describing this new architecture, the inventor uses a new terminology, informationbase, because it provides not only the information and knowledge, but also the functionalities for information management and automation construction.

As depicted in diagram 1, the present invention consists a multi-tiers architecture.

The present invention presentation tier provides all business information management and user business applications.
Business knowledge management—the business knowledge include the business domain, marketing, strategy, operation, process, organization hierarchy, staff, and business requirement, etc.
Corporate information planer—Provide the main information management functionalities, including corporate information strategy, policy, information planning and road map based on the business requirement, corporate information architecture, corporate information infrastructure, AS-IS and TO-BE business functionalities and applications, data ownership, information quality measurement, and development budget and resources requirement at corporate level.
Information automation designer and simulator—based on the design of the corporate information architecture and information infrastructure from corporate information planner and with the organized information from the AIMS informationbase, user can layout the detail application user interface, the detail automated task structure in business process, and the detail data architecture from business data requirement. By just pushing one button, the AIMS generates the application, database, and tasks in AIMS CMC architecture. All project documents will be automatically generated too. By using the AIMS simulator, the user can test the new applications in the AIMS CMC architecture. User can have the option to implement their applications in the convention Non-AIMS environment, but AIMS can manage the information and document only and will not be able to manage the user applications in this case. User also can use the information of the current operational databases and business requirements from the AIMS informationbase to generate and to configure the data warehouse and ETL automatically.
Project management—based on the corporate plan, layout the detail and manage the progress and resources for project(s), including all auto-generated project document, e.g., requirement document, design document. This function is particular important in supporting Non-AIMS projects.
Corporate modeling and database management—provides the model and database management capability. Even with a one-push-button, the analysis and design phase artifacts and auto-generated data model will be added to the object model, automation model, and technical metadata repository and will be viewable by the users. It also provides the management of the database systems and generates the sample or test data. Again, this function will be important if user selects the Non-AIMS conventional information application development approach.
Corporate document and Web resources management—provides the functionalities of corporate and Web (non-XML or XML Semantic) document and storage management (warehousing) and establish a Web knowledgebase by using the resources from the Internet. Will be detailed in another patent application.
Corporate Terminology Management—provide a quick search for the corporate standard business terminology and semantics.
AIMS & Non-AIMS User Applications—In addition of the AIMS information management applications, the user can use the AIMS informationbase and designer to generate many user business applications in AIM architecture or Non-AIMS applications to support their daily business operations and decision supports.

The present invention second tier provides the AIMS information message exchange, database access, and automation functionalities. This tier includes the Web server(s), AIMS generic automation server for messaging, ETL and data acquisitions, AIMS intelligent CMC business automation server, AIMS architecture description and project document generator, and other application server(s). AIMS automation is a higher layer above the automation server.

The present invention third tier, database tier, consists the AIMS informationbase foundation database. The AIMS informationbase includes a business automation rule base for the business automation, a metadatabase for all kinds of business or technical metadata, and the information database for business and project. XML and presentation rule base is part of the foundation database too.

The present invention third tier, database tier, also consists the AIMS generated or Non-AIMS user operational databases, data warehouse, ODS and their staging area.

As depicted in diagram 2, the present invention consists of several generic automation management servers, intelligent CMC business automation servers, and many databases for informationbase foundation database and user operational databases and data warehouse. This is a system and operation architecture that is different from the tier architecture in diagram 1.

The present invention provides a virtual informationbase foundation database, which includes business information and project management database, automationbase(s), and virtual metadatabase. As the nature of the distributed system and databases in most corporate, the AIMS architecture is designed for this distributed environment. By using the mixture of technologies of pointer with real time dynamic background extraction or real time synchronization messaging, the virtual informationbase foundation database abstracts this distributed nature from the user and performs like one (virtual) database. A temporary duplicated copy back up may be adopted if synchronization messaging or real time extraction from the source database may encounter temporary unavailability problem.

The present invention consists the business and project information database and automationbase(s). The business and project information database provides the information required by the business knowledge management, information planner, project management, document management and terminology management. The automationbase supports both of state-of-art generic automation management system (GAMS) technology and intelligent CMC automation technology.

The present invention has a virtual metadatabase. This virtual metadatabase again abstracts from the distributed all kinds of metadata such as data semantics repository, standard code repository, reference data database(s) and inhomogeneous AS-IS physical database related technical metadata repositories, etc. It provides the user with both business view and technical views of all enterprise data in different business contexts. It also provides the information for data quality measurement and impact analysis. Data provisioning for any future business application will be a matter of browsing the metadatabase and selecting the needed data element matches to business object. Once required data elements are identified, all the appropriate attributes will be readily available for software development life cycle. New context names of the same data element can be created to fit the business needs, but data elements created through the model will be strictly managed for reuse and sharing among other business applications.

The present invention includes data semantics database. To achieve the enterprise wide information collection and management, the AIMS data semantics database utilizes an enterprise wide data model that incorporates the international recognized ISO/IEC11179 standard with modifications and enhancements. This database captures all kinds of AS-IS and TO-BE data semantics that is required by a business enterprise. This database also may store the standard code used in a corporate or it may point to the reference data database if the configuration will be decided to have a separated reference data database if the data set is too huge or due to the other configuration reason. This database may be configured as distributed hierarchical repositories. At the same time, it also supports the metadata registry to establish corporate data standard for the data management.

The present invention may consist database related technical metadata repository that stores all AS-IS physical database implementations. This metadata collection may provide one approach of metadata standard consolidation, but not necessary to be the only approach.

The present invention may have reference data database(s) as discussed in [0008]. This configuration can release the storage burden of data semantics database and/or technical metadata repository.

The present invention provides a TO-BE simulation test database for the TO-BE automation and application testing purpose. This test can be done parallel to the to-be-replaced AS-IS production environment.

The present invention consists the AIMS generated or Non-AIMS user databases, such as user operational and data warehouse databases.

The present invention may support the Non-AIMS applications. It may also support or link to the external Non-AIMS data modeling tools. The external modeling tools can either use the XML metadata exported by AIMS or may directly use the metadata in AIMS databases.

The present invention consists the generic automation management system (GAMS), which can be configured into the messaging hub, ETL and integration, or acquisition tools. The acquisition tools acquire the metadata from the source databases or other sources. These tools also monitor sources changes. It will check the metadata quality in metadata acquisition and put those unqualified metadata, e.g., no definition, into non-qualified metadata storage area for further editing by the user before populating into the metadatabase.

The present invention includes the intelligent CMC business automation (management) server (BAMS) for the intelligent business automation management. The GAMS and BAMS are state-of-art technologies. They can be operated as an independent system outside AIMS. However, to use them together with AIMS, the power can be exponential increased. The difference between GAMS and BAMS is that BAMS uses the multi-layer CMC technology with more management intelligence and can be used in more sophistic missions.

In conjunction with the enterprise information model, the Automated Information Management System (AIMS) also provides an automation architecture, GAMS and BAMS, that enable intelligent and fully automated control and management on all business operations with platform independent and web anywhere capability. The CMC is creating an architecture over the network to simulate the human operation and management structure with management intelligence. User is able to organize jobs, schedule jobs, monitor and control the job streams dynamically from anywhere at anytime to insure proper handling of the entire business operation. This infrastructure is a web enabled solution software platform designed to control, manage and co-exist with multiple applications. Each application running under this infrastructure will be identified as a TASK and manage by a task group manager. Once employed, it is fully integrated with applications and thus becomes the management platform of all tasks (applications). Once integrated, the platform will control how, when, what the task should execute and provide monitoring and dynamic execution control capability. User can interrupt, halt and continue any task running under the platform at any point in time of the task from anywhere under the enterprise network. User can also divide a complex task into sub-tasks and require the platform to manage the complexity of the original task. Because of this ability, the AIMS automation allows user to alter complex application drastically with minimal effort. The number of task groups managed by AIMS automation is limited only by the capacity of hardware resources in which AIMS automation is implemented.

As depicted in diagram 3, the present invention consists a core conceptual model for the AIMS informationbase. Based on many years IT experiences, I separated the data objects from the other information objects, which will focus on the data only.

The present invention provides an information object entry. AIMS takes all corporate information resources as information objects that include objects in the following models.

Data Semantics and Object Model which implemented the ISO11179 metamodel with my modifications and enhancements.
Data Element (with derivation, example, presentation, and self-association)
Concept (with object class and self-association)
Conceptual Domain (with value meaning)
Value Domain (with permissive value)

All objects associate with Administration, Name and definition in Context, Classification, Reference Document, etc. as defined in ISO 11179 metamodel.

Business and Information Model—provides the business operation information, information architecture, and XML formatting. All notations will support both of UML (Unified Model Language, an industrial standard from OMG) and business user-friendly icons.
Business Object (with self-association)
Business Strategy
Business Hierarchy
Business Operation
Presentation
XML Schema

Rule Model—Generic Rule base.
Business Rule (with self-association)
Transformation
Mapping
Inference Rule
Protocol (collections of ANSI, ISO or other standards)

Automation Model—support all the Generic Automation Management System (GAMS) and intelligent CMC Business Automation management System (BAMS). All rules are derived from Rule Model.
Task (with self-association)
Business Sequence
Process Rule
Format Rule

Project Information Model—manage all project related information such as time frame, progress and resources, etc.
Project (with self-association)
HW, SW, NW—Hardware, software, and network used in the project.
Staff—This is also for generic personnel management.
Organization—This will derive from the organization hierarchy in Business Model.
Document—This is also for generic document management.
Application System

Data Asset—This data assets form the metadatabase, which will only focus on the data related object.
Data Element (Same as the Data Element in Data Semantics Model)
Standard Code Set & Reference Data
Technical metadata Object

1. I claim a design of integrated system functional and corporate foundation database architecture, AIMS informationbase, in an inhomogeneous distributed corporate IT environment, which comprise the management functionalities, corporate foundation database architecture and business automation architecture and operations. And it is operated as an integral part of the enterprise process. It comprises (1) Business knowledge management (2) information planning and management (3) business automation and application design, construction (by one-push-button) and testing (4) project and document (Corporate and Web, XL semantic or non-XML) management (5) modeling management (6) user business automation applications operation and management (7) a foundation database comprising the business and project information database, metadatabase, and business automation rule base (8) AIMS generated and managed user operation databases. In addition, the metadatabase comprises the ISO 11179 metamodel.
As I claimed in claim 1, a design of an informationbase fundamental enterprise model addresses Information Technology issues from a comprehensive approach. The design of applying a single information object entry in the foundation database is for discovering of any information object in an enterprise.
As I claimed in claim I, a one-push-button automated generating of the business application automation, database(s), and project documents, is a fully information automation by using the AIMS informationbase.
As I claimed in claim 1, this integrated generic platform architecture is operated as an integral part of the enterprise process. This specific feature enables the enterprise to alter business process in real time dimension.
As I claimed in claim 1, a design of virtual metadatabase in an inhomogeneous distributed corporate IT environment comprises an organized data semantics database, physical database related metadata repositories, standard code set and reference databases.
As I claimed in claim 1, my enterprise data model implemented enhanced ISO/IEC 11179 metamodel in my metadatabase for data semantics and for technical metadata consolidation.

2. I claim that AIMS comprises my state-of-art intelligent Computer-Manage-Computer (CMC) automation technology, which has never been published in the public arena.
